(19) United States
(12) Patent Application Publication
(10) Pub. No.: US 2026/0217500 A1
(43) Pub. Date: Jul. 30, 2026

(54) SWITCHBOARD POWER EQUIPMENT LIFTING DEVICE

(71) Applicant: LS ELECTRIC CO., LTD., Anyang-si, Gyeonggi-do (KR)

(72) Inventor: E Jae CHOI, Anyang-si, Gyeonggi-do (KR)

(21) Appl. No.: 19/144,622

(22) PCT Filed: Jan. 4, 2024
(86) PCT No.: PCT/KR2024/000169

§ 371 Date: Jun. 30, 2025

(30) Foreign Application Priority Data
Jan. 9, 2023 (KR) 10-2023-0002671

(51) Int. Cl. B66C 19/00; B66C 11/04

(52) U.S. Cl. CPC B66C 19/00; B66C 11/04

(57) ABSTRACT

The present disclosure relates to a switchboard circuit breaker lifting device comprising: a rail part positioned on the switchboard; an elevation part which is guided to move back and forth and left and right on the rail part, and which lifts power equipment; and a lifting bracket which is fixed to two facing side surfaces of the power equipment, and which is coupled to a hook block of the elevation part so as to move upward and downward in response to action of the elevation part, wherein the elevation part can include: a winding roller for winding a wire to which the lifting bracket is fixed; a gearbox for rotating the winding roller; and a rotation lever which is rotated by mean of an operation mechanism and which operates the gearbox.

### CROSS-REFERENCE TO RELATED APPLICATIONS

This application is a National Stage of International Application No. PCT/KR2024/000169, filed Jan. 4, 2024, which claims priority to and the benefit of Korean Patent Application No. 10-2023-0002671, filed Jan. 9, 2023, the disclosures of which are incorporated herein by reference in its entirety.

### FIELD

The present disclosure relates to a device for lifting a power equipment of a switchboard, and more particularly, to a lifting device capable of preventing safety accidents such as falling over.

### BACKGROUND

In general, power distribution facility is an important factor in the design of a good power system. The choice of switchgear and switchboard among them should be selected through various considerations for the power system.

The switchgear uses a circuit breaker that houses high-voltage wiring, switch, protection relay, etc. together in a metal box based on ANSI standard C37.20.1, UL standard 1558, and NEMA standard SG-5.

According to the UL standard 1558, the circuit breaker, which is the metal box, is configured to be loaded in multiple stages in the vertical direction and up to four stages are loaded in one section. Therefore, the compartment accommodating the topmost circuit breaker is high, and thus the circuit breaker must be loaded into the compartment after lifting.

Conventionally, various lifting devices are used to load the circuit breaker in the switchboard having the compartment that comply with the UL standard 1558, examples of these lifting devices are as follows.

FIG. 1 is a configuration diagram of a conventional method using a trolley-type lifter, FIG. 2 is an explanatory diagram showing a state in which a circuit breaker is loaded on a pedestal of the trolley-type lifter, and FIG. 3 is a schematic diagram of a process of lifting the circuit breaker using the trolley-type lifter.

Referring to FIGS. 1 to 3, conventionally the box-type circuit breaker 300 may be loaded on the switchboard 200 using the trolley-type lifter 100.

As mentioned above, one section of the switchboard 200 is provided with vertically arranged four compartments 210, 220, 230, and 240, and the trolley lifer 100 including a liftable pedestal 110 and movable wheels 120 can be used to load the circuit breaker 300, which is a weight, into the uppermost compartment 240.

In order for an operator to load the circuit breaker 300 into the uppermost compartment 240, the circuit breaker 300, which is a heavy object, must be placed on the pedestal 110 by manpower while the pedestal 110 of the trolley-type lifter 100 is moved to the lowest position as shown in FIG. 2.

At this time a safety accident can occur.

Then, the trolley-type lifter 100 on which the circuit breaker 300 is mounted is pushed toward the switchboard 200 using the wheel 120, and the pedestal 110 on which the circuit breaker 300 is placed is moved upward to load the circuit breaker 300 into the uppermost compartment 240.

In this case, the pedestal 110 is elevated by a chain or a hydraulic jack, and to prevent safety accidents during this process, the wheels 120 are locked to fix it in place.

Then, when the pedestal 110 raises and positions the circuit breaker 300 in front of the uppermost compartment 240, the circuit breaker 300 is inserted into the compartment 240 and loaded.

At this time, as a loading method, the lock is released, and the trolley-type lifter 100 is pushed toward the switchboard 200 until the circuit breaker 300 is positioned very close to the compartment 240, and then, the circuit breaker 300 can be pushed by manpower into the compartment.

However, the task of loading the heavy circuit breaker 300 into the compartment 240 at a relatively high position is not easy, and there is also a concern that the trolley-type lifter 100 can fall over if the heavy the circuit breaker 300 is positioned eccentrically toward one side of the trolley-type lifter 100.

As described above, in conventional methods using the trolley-type lifter 100 to lift the circuit breaker, manual intervention by the operator is required, there is a problem in that there is a concern of safety accidents due to the handling characteristics of the heavy objects, and there is a risk of falling over.

FIG. 4 is a configuration diagram showing an example of lifting of a circuit breaker using a conventional crane, and FIG. 5 is an explanatory diagram showing a lifting process using FIG. 4.

Referring to FIGS. 4 and 5, a crane 400 may be installed on an indoor ceiling of an electric room, and a circuit breaker 300, which is a heavy object, may be lifted and moved using a hook block 420 is raised and lowered by a hoist 410.

In reality, a bridge crane has a complex configuration, including multiple rails and a trolley that can move along the rails and supports the hoist, but the configuration is simplified in FIGS. 4 and 5.

The operator manipulates a remote controller (or pendent) to operate the hoist 410 of the crane 400, thereby moving the hook block 420 downward.

Then, the circuit breaker 300, which is a metal box, is hung and fixed to the hook block 420.

In this case, in order to fix the circuit breaker 300 to the hook block 420, a method of hanging the rope 310 to the hook block 420 is used in a state in which a separate rope 310 is fixed to the circuit breaker.

Then, the hook block 420 is moved upward again so that the circuit breaker 300 is located in front of the uppermost compartment 240.

In this state, the hook block 410 can be moved along the rail and the circuit breaker 300 can be loaded into the compartment 240.

Although the method of using the crane can reduce the intervention of manpower compared to the method of using the trolley-type lifter described above, the circuit breaker 300 may collide with the switchboard 200 due to operator error or shaking of a wire rope, and the circuit breaker 300 may fall upon impact to cause safety accidents.

In particular, since the rope 310 having a predetermined length needs to be applied to fix the circuit breaker 300 to the hook block 420, shaking occurs at the connection between the rope 310 and the hook block 420, which further increases the risk of collision or falling.

In addition, since the length is unnecessarily long due to the use of the rope 310, the shaking may occur more significantly.

In addition, since the crane is very expensive to install, it is not easy to install, which can lead to an increase in costs during installation, and in reality, the crane is more often not installed in the electric room.

Due to the problems of such conventional technologies, there is a need for a circuit breaker lifting device that is safer and can minimize an increase in cost in the current market.

### SUMMARY

The problem that the present disclosure, which reflects the market demand as described above, seeks to solve is to provide a power equipment-lifting device capable of efficiently lifting and loading the power equipment into a switchboard compartment while minimizing cost input.

In particular, the specific problem that the present disclosure seeks to solve is to provide a power equipment-lifting device capable of preventing safety accidents or damage to a power equipment or a switchboard by preventing the power equipment from shaking during lifting.

In addition, another problem that the present disclosure seeks to solve is to provide a power equipment-lifting device capable of preventing foreign substances from entering a power equipment during lifting and improving stability.

In order to solve the technical problem described above, a power equipment lifting device of the present disclosure may include a rail configured to have a first guide disposed in a left and right direction on an upper side of the switchboard, and a second guide movable in the left and right direction along the first guide; and an elevator configured to move in a forward and rearward direction while being guided by the second guide, the elevator lifting the power equipment, and wherein the elevator includes a winding roller configured to wind a wire for lifting the power equipment, a gear box configured to rotate the winding roller, and a rotation lever configured to operate the gear box.

In an embodiment of the present disclosure, the gear box may include a worm and a worm wheel, and a housing configured to accommodate the worm and the worm wheel, thereby preventing a drop of foreign substances generated from the worm and the worm wheel.

In an embodiment of the present disclosure, the worm may be rotated according to the rotation of the rotation lever, and the worm wheel may be engaged with the worm, and have a central portion coupled with a central portion at one end of the winding roller to transmit a rotational force from the worm to the winding roller.

In an embodiment of the present disclosure, the switchboard may be a multi-section switchboard in which a plurality of sections, each including compartments vertically arranged in one row, are arranged side by side in the left and right direction, and the rail may include the first guide located across the entire upper side of the multi-section switchboard, such that a single elevator is capable of lifting the power equipment onto the compartments of all the sections.

In an embodiment of the present disclosure, a hole may be formed in the first guide, and a fixing pin may be inserted into the hole to fix the elevator in place while the elevator is positioned at one of the plurality of sections.

In an embodiment of the present disclosure, the rail may include a moving block with which a roller is rotatably coupled on a lower side of the second guide, and another hole aligning with the hole of the first guide may be formed in the moving block while the elevator is positioned in place at the section, and the fixing pin may be inserted therein.

The present disclosure provides the lifting device that is movable from the upper end of the switchboard to protrude toward the front side of the switchboard, thereby enabling a stable lifting of the power equipment while minimizing cost.

In addition, the present disclosure also prevents foreign substances generated from gears engaged during lifting from being dropped onto the power equipment.

The present disclosure also lifts the power equipment in a plurality of sections by using one elevator, and fixes the elevator so as to be impossible to move in a state in which the elevator is positioned in place at a specific section, thereby enabling a stable lifting operation to be performed.

### BRIEF DESCRIPTION OF THE DRAWINGS

FIG. 1 is a configuration diagram of a circuit breaker lifting device using a conventional trolley-type lifter.

FIG. 2 is an explanatory diagram showing a state in which a circuit breaker is loaded on a pedestal of the trolley-type lifter.

FIG. 3 is a schematic diagram of a process of lifting the circuit breaker using the trolley-type lifter of FIG. 1.

FIG. 4 is a configuration diagram of a circuit breaker-lifting device using a conventional bridge crane.

FIG. 5 is an explanatory diagram showing a lifting process using FIG. 4.

FIG. 6 is a configuration diagram of a switchboard power equipment-lifting device according to an exemplary embodiment of the present disclosure.

FIG. 7 is a perspective view of a switchboard in a state in which the present disclosure is installed.

FIG. 8 is a configuration diagram of a rail 20 applied to the present disclosure.

FIG. 9 is an exemplary diagram of a hoist applied to the elevator.

FIG. 10 is a configuration diagram of a gear box of a hoist.

FIG. 11 is a configuration diagram of a state in which the gear box of the hoist is operated using an operating mechanism.

FIG. 12 is an unfolded perspective view of the lifting bracket applied to the present disclosure.

FIG. 13 is a front view showing an example of the use of the lifting bracket 30 in stages.

FIG. 14 is a perspective view of an example in which the present disclosure is applied to a switchboard having a plurality of sections.

FIGS. 15 and 16 are configuration diagrams for explaining a fixing structure of the elevation, respectively.

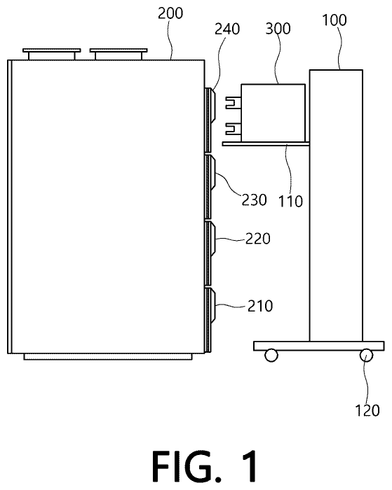

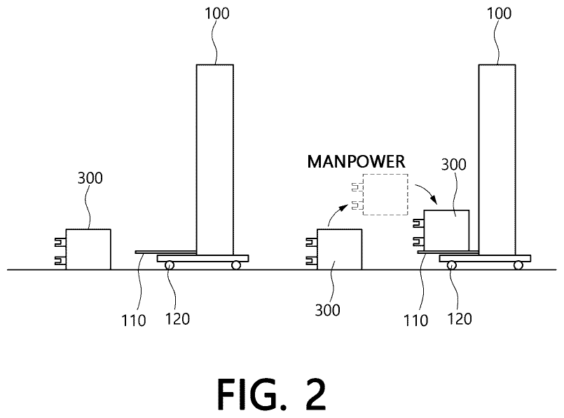

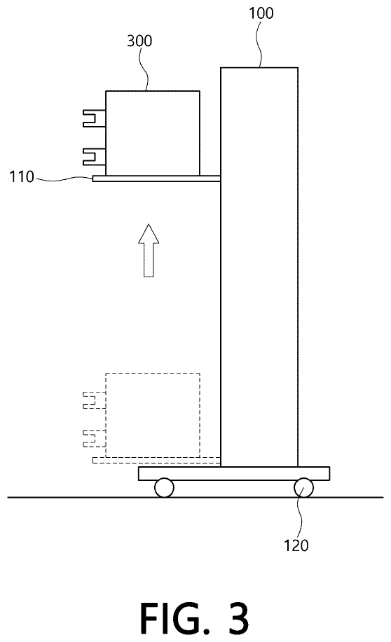

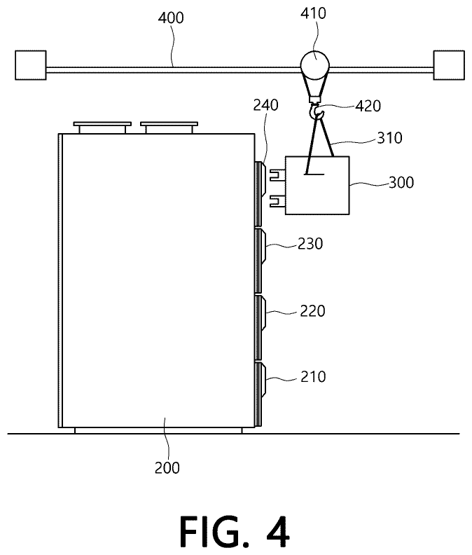

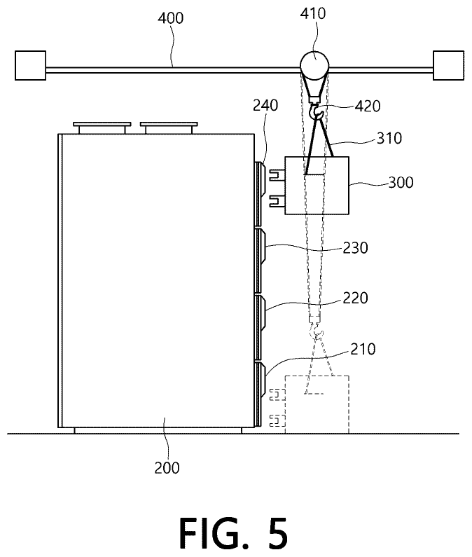

### DETAILED DESCRIPTION

In order to fully understand the configuration and effect of the present disclosure, preferred embodiments of the present disclosure are described with reference to the attached drawings. However, the present disclosure is not limited to the embodiments disclosed below, but may be implemented in various ways and various changes may be made. However, the description of the present embodiments is provided so that the disclosure of the present disclosure is thorough and complete, and the scope of the present disclosure is fully known to those skilled in the art to which the present disclosure belongs. In the accompanying drawings, components are shown to enlarge their size than the actual size, and the ratio of each component may be exaggerated or reduced.

The terms ‘first’, ‘second’, and the like may be used to describe various components, but the components should not be limited by the above terms. The above terms may be used only to distinguish one component from another. For example, the ‘first component’ may be referred to as the ‘second component’, and similarly, the ‘second component’ may be referred to as the ‘first component’ without departing from the scope of the present disclosure. In addition, the singular expression includes a plural expression unless the context clearly dictates otherwise. The terms used in the embodiments of the present disclosure may be interpreted as a meaning commonly known to those skilled in the art unless otherwise defined.

Hereinafter, a device for lifting a power equipment of a switchboard according to an embodiment of the present disclosure will be described in detail with reference to the drawings.

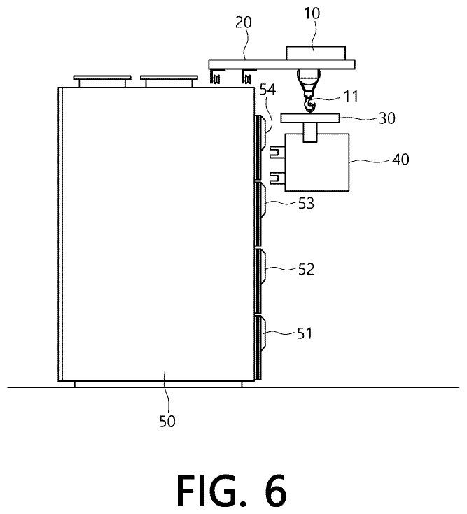

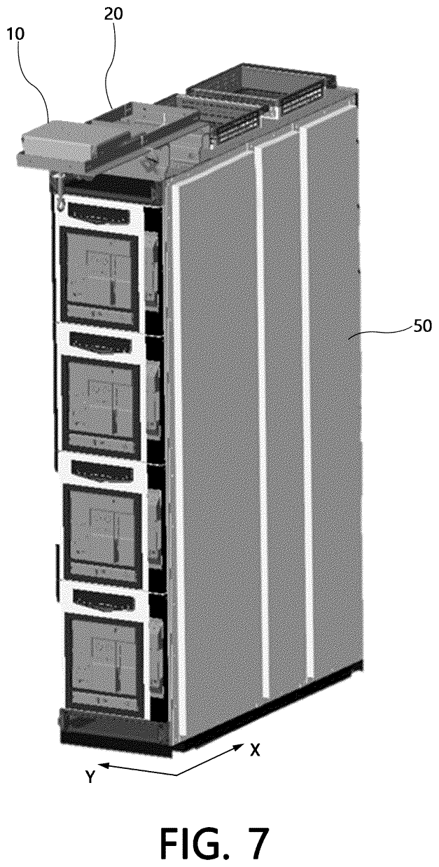

FIG. 6 is a configuration diagram of a switchboard power equipment-lifting device according to an exemplary embodiment of the present disclosure, and FIG. 7 is a perspective view of a switchboard in a state in which the present disclosure is installed.

Referring to FIGS. 6 and 7, the switchboard power equipment-lifting device according to an exemplary embodiment of the present disclosure includes a rail 20 which is installed on an upper surface of the switchboard 50 and of which a portion may protrude forward from the front of the switchboard 50 if necessary, an elevator 10 that is movable along the rail 20 and is capable of moving a hook block 11 up and down when in a state of being protruded from the front of the switchboard 50, and a lifting bracket 30 that is fixed to grooves on both side of the power equipment 40, coupled with the hook block 11 of the elevator 10, and moves together with the hook block 11 to lift the power equipment 40.

Hereinafter, a configuration and an operation of the switchboard power equipment-lifting device according to an exemplary embodiment of the present disclosure configured as described above will be described in detail.

First, the power equipment-lifting device of the present disclosure is installed on an upper surface of the switchboard 50 to secure safety such as preventing falling over and to minimize costs.

FIG. 7 shows the switchboard 50 corresponding to one section, and by applying one elevator 10 to the switchboards 50 of a plurality of sections, the power equipment 40 may be lifted and loaded into each compartment of the plurality of sections. This feature will be described in more detail below.

The power equipment 40 may be a circuit breaker.

The rail 20 installed on the upper surface of the switchboard 50 may be applied to the present disclosure regardless of its structure as long as it is possible to move the elevator 10 in the x-axis and γ-axis directions.

The x-axis movement of the elevator 10 is to allow the power equipment 40 to be moved closer to the compartment after being lifted, and the elevator 10 is positioned on the upper side of the switchboard 50 when the elevator 10 is not used to secure stability.

In addition, the y-axis movement is to allow the power equipment 40 to be loaded into the compartments located in all sections using one elevator 10 when the switchboard 50 of FIG. 7 has a structure having the plurality of sections disposed in contact with the left or right side.

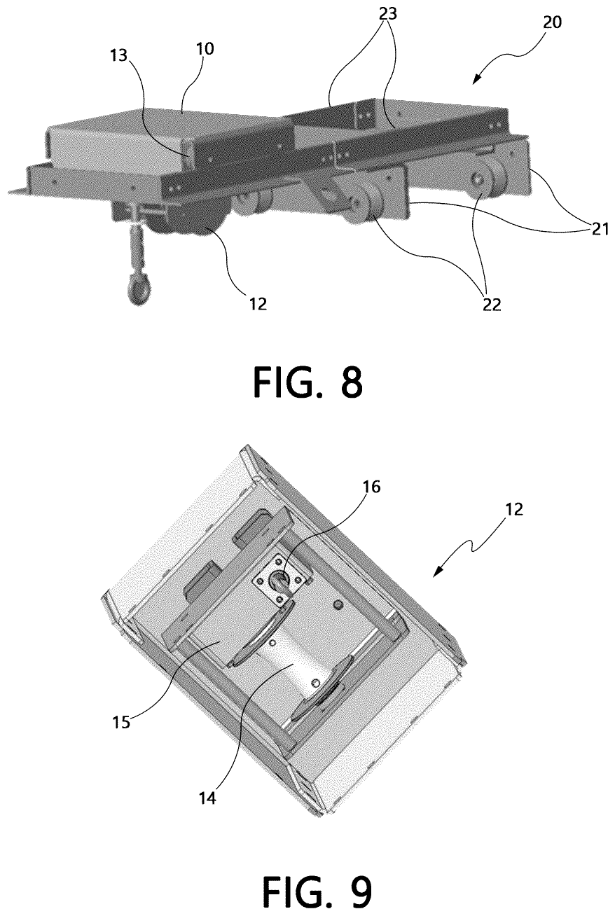

FIG. 8 is a configuration diagram of a rail 20 applied to the present disclosure.

Referring to FIG. 8, the rail 20 may include a pair of first guides 21 elongated in the y-axis direction, a first roller 22 provided on a side surface of the first guide 21, and a pair of second guides 23 located on an upper side of the first guide 21 and movable in the y-axis direction according to rotation of the first roller 22 and elongated in the x-axis direction.

In the above embodiment, a driving means such as a motor and a power transmission means such as a belt or a gear for transmitting a driving force of the driving means to the first roller 22 are omitted, and omitted components may be easily designed by a person with ordinary skills in the art to which this disclosure belongs.

In the above-described embodiment, the first roller 22 is shown, and a configuration in which the second guide 23 moves along the y-axis direction by rotation of the first roller 22 is described, but the first roller 22 may not be formed on the first guide 21 but may be formed on the second guide 23.

This means that the rail 20 may be configured in various forms, and the rail 20 of the present disclosure may be applied to the present disclosure if the structure guides the elevator 10 to move freely in the x-axis and γ-axis directions with respect to the ground, and more precisely, in the forward and rearward direction, and the left and right directions of the switchboard 50.

The elevator 10 may move the above-described hook block 11 up and down by including the hoist 12, and the second roller 13 may be provided on the side surface of the elevator 10 so that it comes into contact with the second guide 23, and the elevator 10 may move in the forward and rearward direction of the switchboard 50 along the second guide 23 in the x-axis direction.

In the above example, the second guide 23 is shown as having a single structure, but the guide itself may be designed as a double structure capable of extending and shortening, so that the elevator 10 may be positioned on the upper side of the switchboard 50 when shortened, and the elevator 10 may protrude toward the front side of the switchboard 50 when extended.

In this case, power equipment-lifting device of the present disclosure may further include a housing for accommodating the shortened second guide 23, and the housing may include a door capable of opening and closing, so that when the second guide 23 is extended, the door is opened and the elevator 10 is protruded.

As described above, by using the rail 20 that may be implemented in various modifications, the elevator 10 may be moved to the front and rear sides of the switchboard 50, so that the power equipment 40 may be lifted and loaded into all compartments of one section (including the compartments arranged up to four above and below).

In addition, by applying to the switchboard 50 having a plurality of sections, at least one elevator 10 may be moved to the left and right of the switchboard 50, the power equipment 40 may be lifted and loaded in the compartments of all sections.

The above-described configuration significantly reduces the manpower input of the operator, and prevents the risk of falling over and secures safety compared to using the conventional trolley-type lifter.

In addition, there is a feature that the installation cost may be significantly reduced compared to the conventional method using the bridge crane.

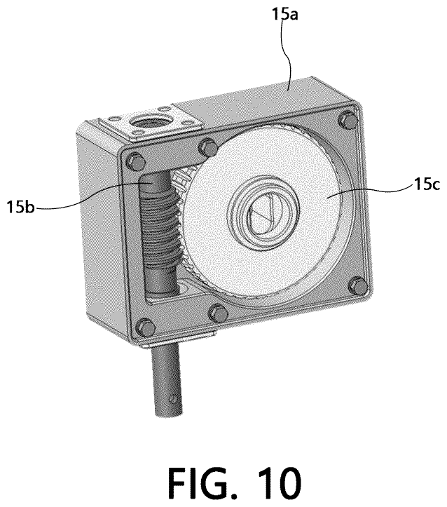

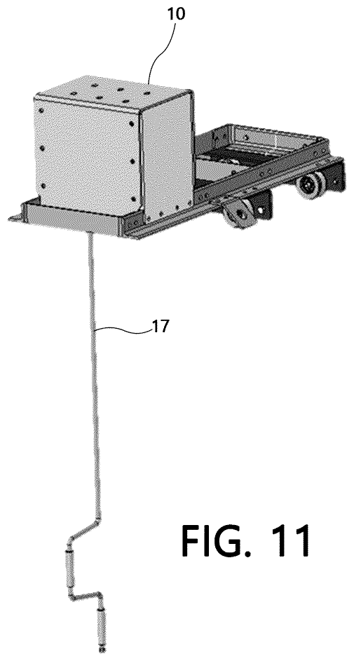

FIG. 9 is an exemplary diagram of a hoist 12 applied to the elevator 10, FIG. 10 is a configuration diagram of a gear box, and FIG. 11 is a configuration diagram of a state in which the gear box 15 of the hoist is operated using an operating mechanism 17.

Referring to FIGS. 9 to 11, the hoist 12 of the elevator 10 includes a winding roller 14 configured to wind a wire, one end of which is coupled with a hook block 11 a gear box 15 configured to rotate the winding roller 14, and a rotation lever 16 configured to operate the gear box 15.

The rotation lever 16 may be rotated by the operating mechanism

The gear box 15 includes a worm 15b and a worm wheel 15c disposed in the housing 15a. The worm 15b is engaged with the rotation lever 16 to rotate, and the worm wheel 15c is coupled with a rotation shaft of the winding roller 14 to rotate the winding roller 14 according to the rotation of the worm 15b.

At this time, the rotation of the winding roller 14 may be clockwise or counterclockwise with respect to the rotation shaft.

Therefore, the hook block 11 may be adjusted to move in the vertical direction, allowing the lifting bracket 30 hung on the hook block 11 and the power equipment 40 hung on the lifting bracket 30 and fixed to it to be moved vertically.

The worm 15b and the worm wheel 15c are in frictional contact with each other, which may generate foreign substances and metal particles; however, since the worm 15b and the wheel 15c are located within the housing 15a, the generated foreign substances and metal particles may be prevented from being dropped onto the power equipment 40.

This structure may also prevent shaking of the power equipment 40 being lifted, compared to the conventional method of using the bridge crane, and the feature of preventing such shaking is due to the unique structure of the lifting bracket 30.

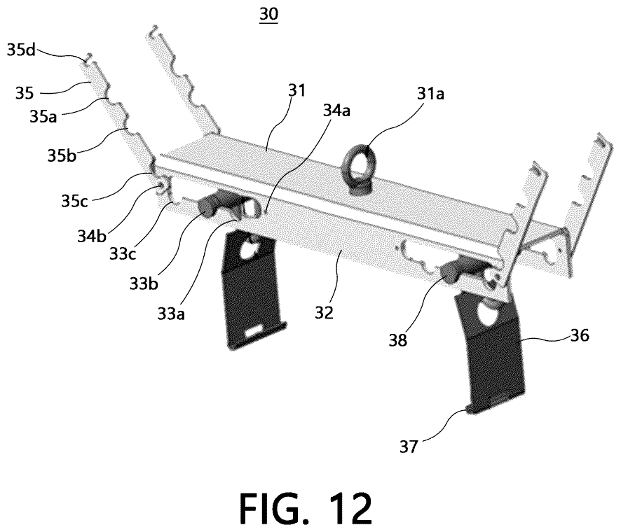

FIG. 12 is an unfolded perspective view of the lifting bracket 30 applied to the present disclosure.

Referring to FIG. 12, the lifting bracket 30 provides a position-variable latch 36 suitable for lifting the power equipment 40 of various sizes, and a frame structure including the upper frame 31 and the side frame 32 is directly hung on the hook block 11, and thus the shaking may be improved compared to a structure using the rope in the conventional bridge crane method, and the risk of falling the power equipment 40 during lifting may be eliminated.

More specifically, the upper frame 31 of the lifting bracket 30 is formed in a long bar shape on one side, and the side frame 32 is bent downwardly to be positioned on two long sides facing each other.

The upper frame 31 and the lower frame 32 may be integrally formed or coupled after being separated.

A circular ring 31a capable of hanging and fixing the hook block 11 is provided at the center of gravity of an upper surface of the upper frame 31.

The side frames 32 include a slot-shaped adjustment hole 33 capable of fixing a pair of latches 36 and adjusting a gap between the pair of latches 36 as necessary.

The shape of the adjustment hole 33 has a close relationship with the structure of the latch 36, and the shape of the latch 36 will be described first before the description of the shape of the adjustment hole 33.

The latch 36 is a plate-shaped structure, and a latching bar 38 is coupled with one end thereof, and the other end is bent upward in a direction in contact with a side surface of the power equipment 40 to form an insert 37.

The power equipment 40 in the form of a metal box has grooves on two side surfaces facing each other according to standards, and the insert 37 is inserted into the grooves.

The length of the latching bar 38 is longer than a gap between the two side frames 32, and thus both ends of the latching bar 38 are inserted into respective adjustment holes 33 formed to face each other on the two side frames 32, to fix the latch 36 having the insert 37 at the end.

The adjustment holes 33 have semicircular insertion grooves 33a, 33b, and 33c formed at different positions, into which a part of the latching bar 38 is inserted.

Therefore, each of both ends of the latching bar 38 may be inserted into the insertion grooves selected from among the insertion grooves 33a, 33b, and 33c to adjust the gap between the two latching bars 38, and finally, the gap between the inserts 37 that are the ends of the latches 36 may be adjusted.

As described above, by adjusting the gap between the inserts 37, the power equipment 40 having a different size determined in the standard specification may be lifted using one lifting bracket 30.

The lifting bracket 30 is provided with a movement prevention portion 35 for blocking movement of the latching bar 38 inserted into a specific insertion groove in order to secure safety during lifting of the power equipment 40.

The movement prevention portion 35 is provided in two parts for each side frame 32 and is provided in a bar-shaped with one end rotatably fixed to the side frame 32 by a pivot 34b.

The position of the pivot 34b is set between both ends of the side frame 32 and the adjustment hole 33.

One end of the movement prevention portion 35 includes insertion grooves 35a, 35b, and 35c corresponding to the positions of the insertion grooves 33a, 33b, and 33c provided in the adjustment hole 33, and when the movement prevention portion 35 is rotated to be in contact with the side surface of the side frame 32, the upper side of both ends of the latching bar 38 is inserted into one of the insertion grooves 35a, 35b, and 35c, thereby restricting the movement of the latching bar 38.

At this time, the fixing pin 34a protrudes between the two adjustment holes 33 formed on each side frame 32, and the insertion groove 35d into which the fixing pin 34a is inserted is provided on the movement prevention portion 35.

As described above, the movement prevention portion 35 is used to fix the position of the latch 36 where the interval adjustment is completed, and may allow stable lifting.

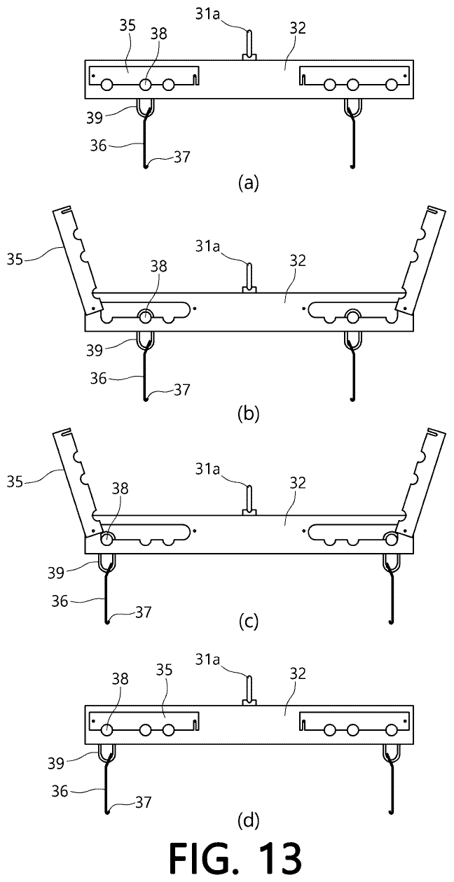

FIG. 13 is a front view showing an example of the use of the lifting bracket 30 in stages.

Part (a) of FIG. 13 shows a “closed state” in which the movement prevention portion 35 is located on the side surface of the side frame 32. Referring to FIGS. 13 and 12, it may be seen that the latching bar 38 is inserted into the second insertion groove 35b of the adjustment hole 33 in part (a) of FIG. 10.

It may be confirmed that the upper side of the latching bar 38 is inserted into the second insertion groove 35b of the movement prevention portion 35 in the closed state.

In the description referring to FIG. 12, although the latching bar 38 is described as being directly coupled with one end of the latch 36, the latching bar 38 and the latch 36 may be connected to each other by using a link 39 as shown in FIG. 13.

When the gap between the latching bars 38 needs to be further widened in order to lift the larger power equipment 40 in the state described above, the operator rotates the movement prevention portion 35 about the pivot 34b as shown in part (b) of FIG. 13.

The rotation direction at this time is upward, and this state is defined as “open state”.

Then, the operator moves the latching bar 38 to the last insertion groove 35c of the adjustment hole 33 and inserts the latching bar 38 into the insertion groove 35c to move the latch 36 to a position where the largest power equipment 40 may be lifted.

In this way, when the movement prevention portion 35 is opened as described above, and the position of the latching bar 38 may be adjusted, and the position of the latch 36 may be adjusted according to the size of the power equipment 40 to be lifted.

Then, the movement prevention portion 35 is manipulated again in the closed state as shown in part (d) of FIG. 13 to prevent the position of the latching bar 38 from being changed during the lifting process.

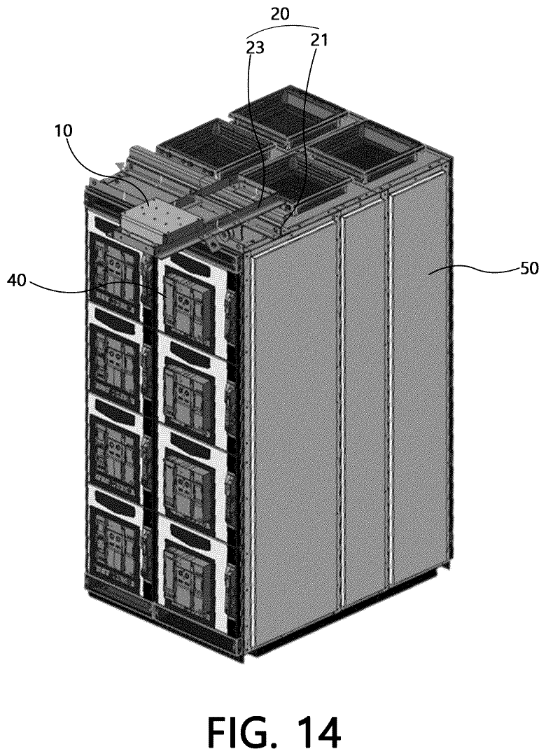

FIG. 14 is a perspective view of an example in which the present disclosure is applied to a switchboard 50 having two sections, and in which a first guide 21 is continuously installed on two sections so that a second guide 23 may move left and right along the first guide 21, and thus the power equipment 40 may be lifted and loaded onto both sections using one elevator 10.

At this time, the moved elevator 10 may be fixed by a pin.

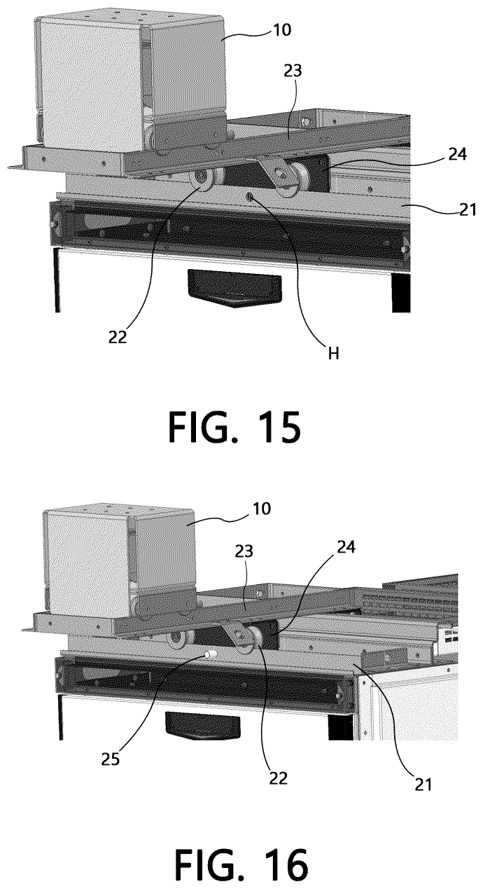

FIGS. 15 and 16 show a fixing structure of the elevator 10, respectively.

Referring to FIGS. 15 and 16, the elevator 10 may move in a forward and reward direction along the second guide 23 on the second guide 23. The second guide 23 may move in a left and right direction along the first guide 21, and thus the elevator 10 on the second guide 23 may also move in the left and right direction.

The moving block 24 may be fixed to a lower end of the second guide 23. The first roller 22 may be coupled with a rotation shaft provided in a part of the moving block 24 to be rotated, and the first roller 22 may rotate while being in contact with the first guide 21 to move the second guide 23 in the left and right direction.

The hole H is formed in the first guide 21 and the moving block 24, and when the elevator 10 moved along the first guide 21 is positioned in place at the section, the hole of the first guide 21 and the hole of the moving block 24 are aligned with each other.

The fixing pin 25 is inserted to penetrate the hole of the first guide 21 and the hole of the moving block 24 to prevent the elevator 10 from moving during a lifting operation.

Therefore, the lifting operation of the heavy power equipment 40 may be performed while maintaining a stable fixed state.

Although the embodiments according to the present disclosure have been described above, these are merely exemplary, and it will be understood by those skilled in the art that various modifications and equivalent embodiments are possible. Accordingly, the true technical protection scope of the present disclosure should be determined by the following claims.

The present disclosure relates to a device capable of safely lifting a switchboard using natural laws, and has industrial applicability.

-List of Reference Numerals-

| | |
|---|---|
| 10: elevator | 14: winding roller |
| 15: gear box | 16: rotation lever |
| 20: rail | 30: lifting bracket |
| 40: power equipment | 50: switchboard |

1. A device for lifting a power equipment of a switchboard comprising:
a rail configured to have a first guide disposed in a left and right direction on an upper side of the switchboard, and a second guide movable in the left and right direction along the first guide; and
an elevator configured to move in a forward and rearward direction while being guided by the second guide, the elevator lifting the power equipment, and
wherein the elevator includes:
a winding roller configured to wind a wire for lifting the power equipment;
a gear box configured to rotate the winding roller; and
a rotation lever configured to operate the gear box.

2. The device of claim 1, wherein the gear box includes a worm and a worm wheel, and a housing configured to accommodate the worm and the worm wheel, thereby preventing a drop of foreign substances generated from the worm and the worm wheel.

3. The device of claim 2, wherein the worm is rotated according to the rotation of the rotation lever, and
the worm wheel is engaged with the worm, and has a central portion coupled with a central portion at one end of the winding roller to transmit a rotational force from the worm to the winding roller.

4. The device of claim 1, wherein the switchboard is a multi-section switchboard in which a plurality of sections, each including compartments vertically arranged in one row, are arranged side by side in the left and right direction, and
the rail includes the first guide located across the entire upper side of the multi-section switchboard, such that a single elevator is capable of lifting the power equipment onto the compartments of all the sections.

5. The device of claim 4, wherein a hole is formed in the first guide, and
a fixing pin is inserted into the hole to fix the elevator in place while the elevator is positioned at one of the plurality of sections.

6. The device of claim 5, wherein the rail includes a moving block with which a roller is rotatably coupled on a lower side of the second guide, and
wherein another hole aligning with the hole of the first guide is formed in the moving block while the elevator is positioned in place at the section, and the fixing pin is inserted therein.
